(19) United States
(12) Patent Application Publication
(10) Pub. No.: US 2007/0048580 A1
(43) Pub. Date: Mar. 1, 2007

(54) Fuel cell

(76) Inventors: Cheng-Hsin Chen, Taipei (TW); Hsi-Ming Shu, Taipei (TW); Ko-Chen Shen, Taipei (TW)

Correspondence Address: G. LINK Co., LTD, 3550 Bell Road, MINOOKA, IL, 60447, US

(21) Appl. No.: 11/213,696

(22) Filed: Aug. 30, 2005

(51) Int. Cl. H01M 2/02; H01M 8/02

(52) U.S. Cl. 429/34; 429/127; 429/38

(57) ABSTRACT

A fuel cell, including a fuel cell core component having an anode current collection portion, at least one membrane electrode assembly, and a cathode current collection portion stacked in a sequential manner; a casing, made of a plastic material for surrounding the fuel cell core component therein.

### FIELD OF THE INVENTION

This invention relates to a fuel cell, particularly to one using a packaging material made of plastic material.

### BACKGROUND OF THE INVENTION

The conventional fuel cell has disclosed the techniques of using a printed circuit board(PCB) fabrication process for manufacturing the fuel cell within a multi-layer PCB. Since the membrane electrode assemblies of the fuel cell are laminated within the multi-layer PCB, the membrane electrode assemblies tend to be exposed to damage during the PCB fabrication process after motile heat treatment required in the fabrication process, so as to significantly reduce the passing rate of the fuel cell and thereby increasing the manufacturing cost.

This invention intends to overcome the shortcomings resulted from the conventional fuel cell, where plastic material is used as the packaging casing of the fuel cell.

### SUMMARY OF THE INVENTION

It is an object of this invention to provide a fuel cell, where plastic material is used as the packaging casing of the fuel cell.

It is another object of this invention to provide a fuel cell, where the packaging casing is made by injection molding process.

To achieve the above objects, this invention provides a fuel cell, including a fuel cell core component having an anode current collection portion, at least one membrane electrode assembly, and a cathode current collection portion stacked in a sequential manner; a casing, made of a plastic material for surrounding the fuel cell core component therein.

This invention may further include a fuel flow board made of a plastic material and joined to an outside surface of the casing, with the surface having an inner side neighboring the anode current collection portion.

### BRIEF DESCRIPTION OF THE DRAWINGS

These and other modifications and advantages will become even more apparent from the following detained description of a preferred embodiment of the invention and from the drawings in which:

FIG. 1 is a perspective view of the fuel cell of this invention;

FIG. 2 is a structural schematic drawing of the fuel cell core component of this invention;

FIG. 3 is a cross-sectional view illustrating an embodiment of the casing of this invention;

FIG. 4 is a schematic view illustrating the fuel cell of this invention, where a fuel flow board is additionally provided thereto; and

FIG. 5 is a cross-sectional view of the fuel cell in FIG. 4.

### DETAILED DESCRIPTION OF THE INVENTION

In this invention, a fuel cell 10 is characterized by a casing 11 that is made of plastic material, such as plastic. Since such kind of material can easily adopt injection molding process and the cost relating to such process is relatively low, the manufacturing cost of the fuel cell is significantly reduced. While selecting the desired plastic material, if the acid-resistant property required by the casing 11 should be taken into consideration, the fuel cell 10 of this invention will be highly suitable to be implemented in a methanol fuel cell.

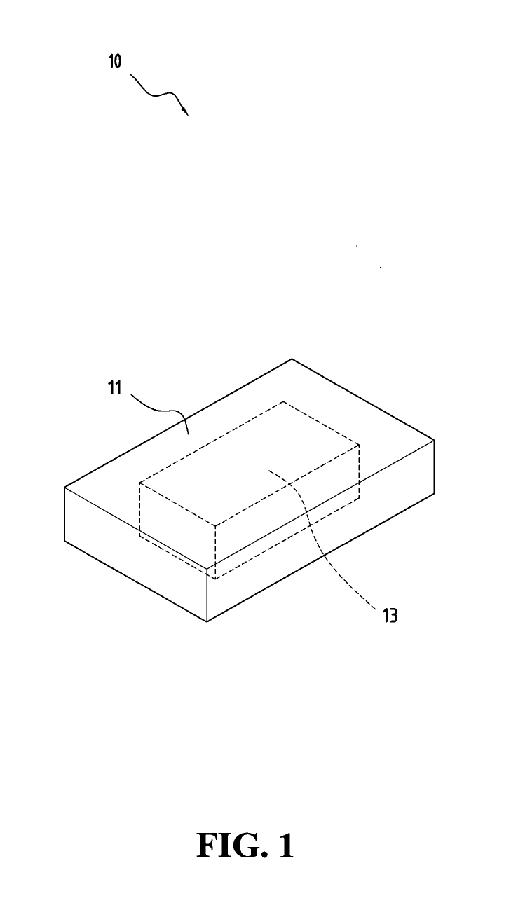

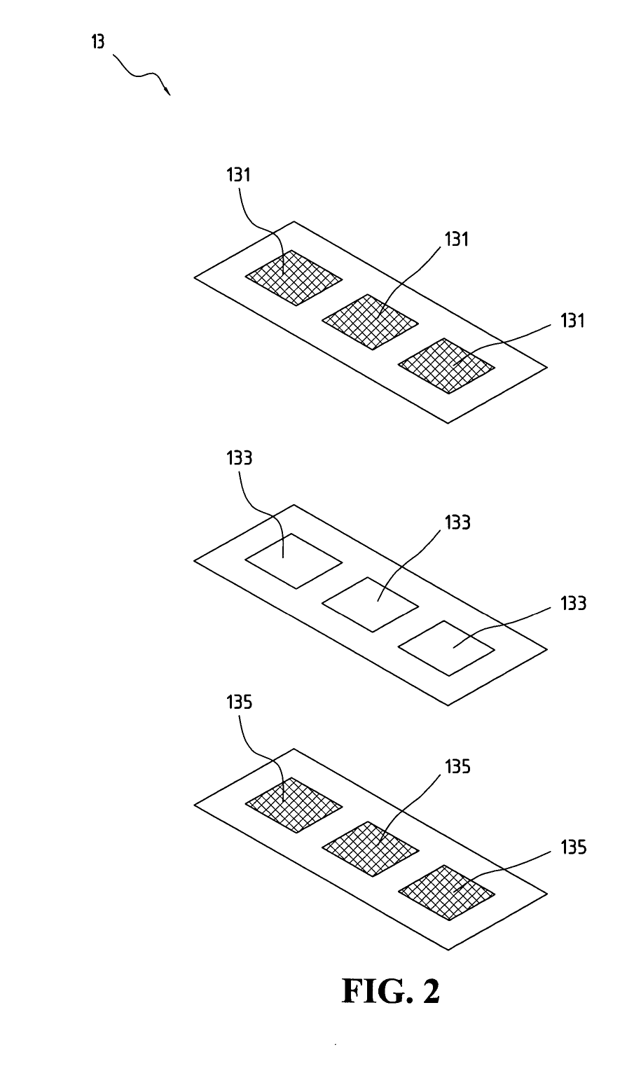

FIG. 1 is a perspective view of the fuel cell of this invention. The fuel cell 10 includes a casing 11 and a fuel cell core component 13. The casing 11 is formed therein with a space for receiving the fuel cell core component 13, such that the casing 11 surrounds the fuel cell core component 13. The fuel cell core component 13 includes a cathode current collection portion 131, at least one membrane electrode assembly 133, and an anode current collection portion 135 that are stacked from the top down. FIG. 2 is a structural schematic drawing of the fuel cell core component 13 of this invention. The fuel cell core component 13 mainly serves to generate electro-chemical reaction thereby generating electrical power. The fuel cell core component 13 of this invention may adopt the conventional fuel cell core component, such that the process for making the fuel cell core component 13 is not described herein. The fuel cell core component 13 of this invention may alternatively be a flexible fuel cell core component, such as one using a flexible circuit board as its substrate. The fuel cell core component 13 may alternatively be made by means of a printed circuit board(PCB) fabrication process.

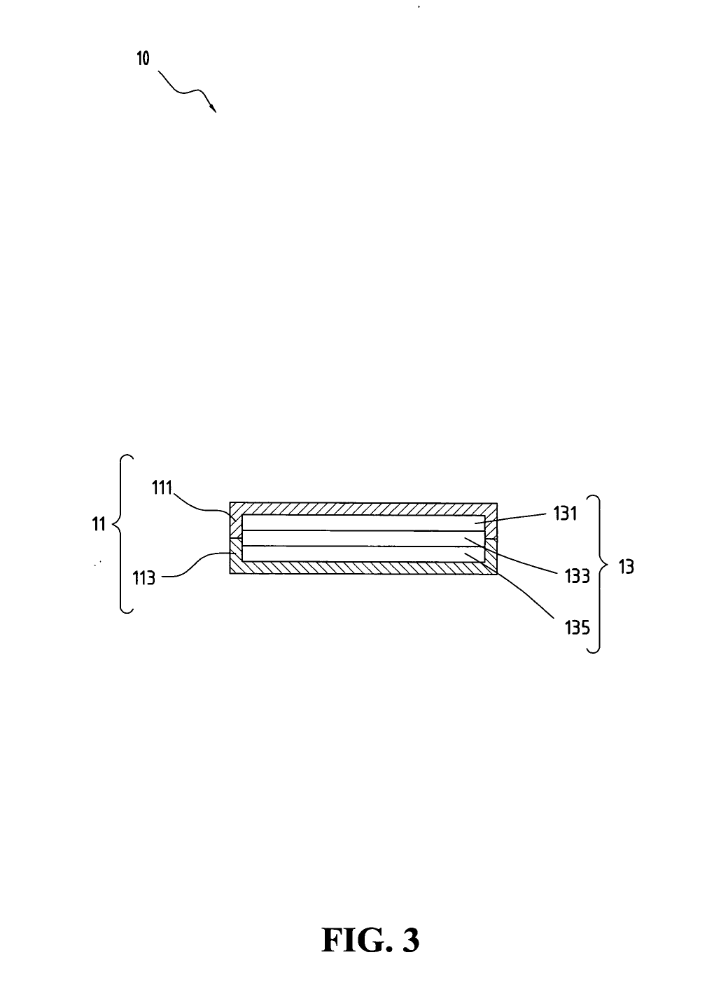

FIG. 3 is a cross-sectional view illustrating an embodiment of the casing of this invention. The casing 11 includes an upper casing 111 and a lower casing 113. The upper casing 111 and the lower casing 113 are, for example, each of an inverse-U configuration, such that joining of the upper casing 111 and lower casing 113 define a space therein for receiving the fuel cell core component 13. First, the upper casing 111 and lower casing 113 may each be made of plastic material by means of injection molding into independent units. Then, while assembling the fuel cell 10, the cell core component 13 is placed between the upper casing 11 and lower casing 113. Finally, ultrasonic waves may be adopted for pressing the upper casing 111 and lower casing 113 together. Furthermore, the measure of using ultrasonic waves to be the joining means requires an extraordinarily short duration, so as to eliminate any damage to the fuel cell core component 13 placed in the space between the upper casing 111 and lower casing 113.

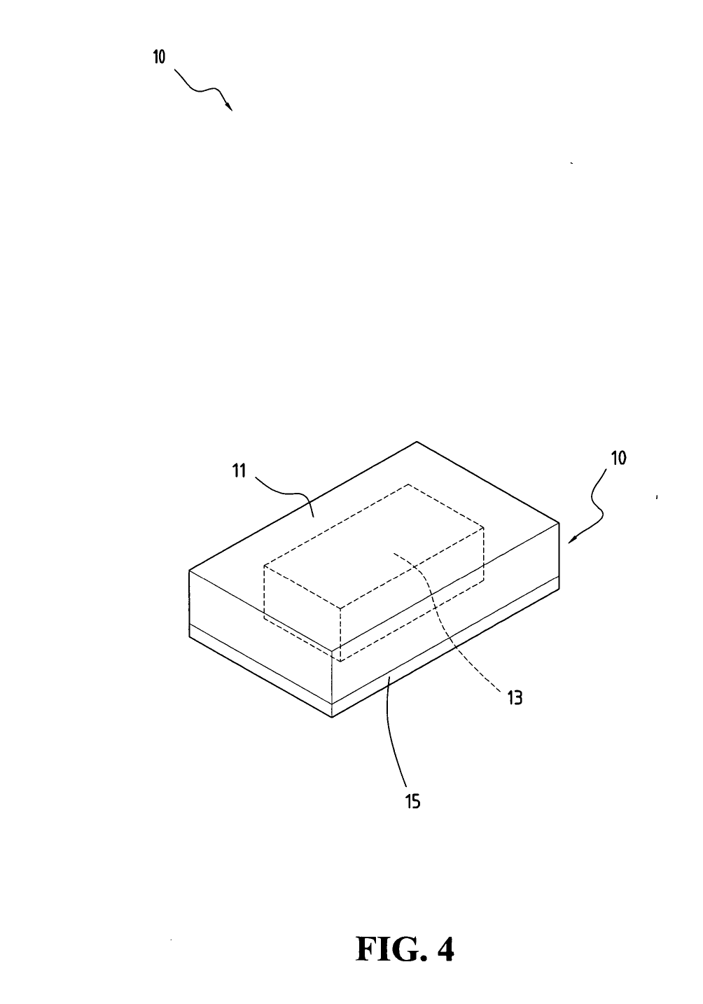

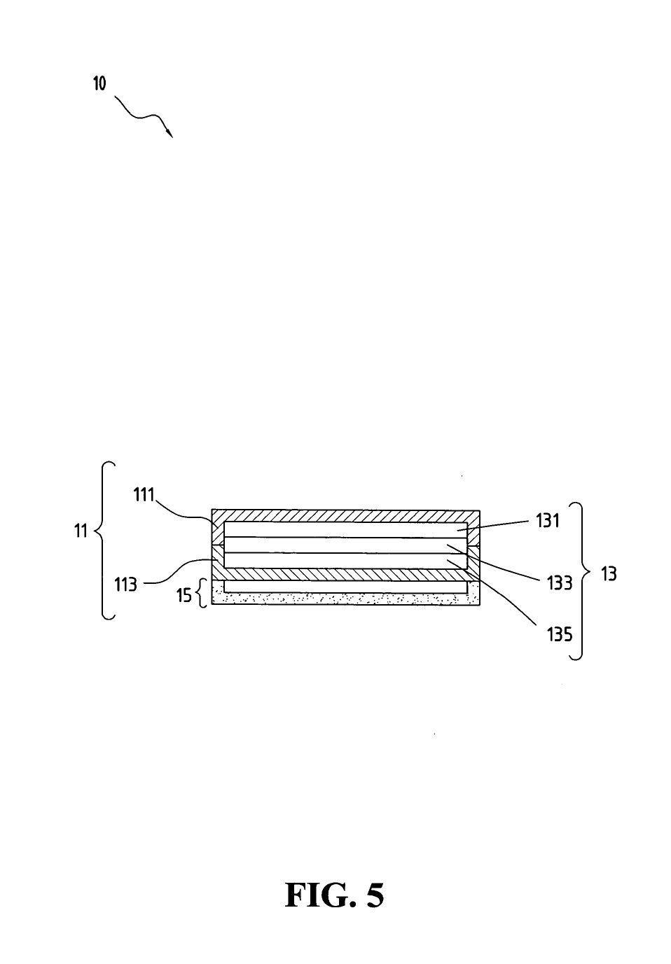

FIG. 4 is a schematic view illustrating the fuel cell in FIG. 1, where a fuel flow board is additionally provided thereto and FIG. 5 is a cross-sectional view of the fuel cell in FIG. 4. The fuel flow board 15 is also made of plastic material by means of injection molding process. The fuel flow board 15 mainly serves to provide a space through which anode fuel (such as methanol solution) flows, causing the anode fuel to flow into the anode terminal of each membrane electrode assembly 133. The fuel flow board 15 may adopt ultrasonic waves as the means for pressing the fuel flow board 15 onto a surface of the casing 11. Since the fuel flow board 15 serves to allow the anode fuel to flow through, it is joined to a surface at the side of the casing 11 where the anode fuel collection portion 135 is located, while pressing the fuel flow board 15 onto the casing.

To ensure that fuel may be supplied to the fuel cell core component 13, in this invention, the upper casing 111 and lower casing 113 may be formed with plural through holes at locations corresponding to the membrane electrode assemblies 133, such that external air serving as cathode fuel would flow to the cathode terminals of the membrane electrode assembles 133 through the upper casing 111. Similarly, the anode fuel in the fuel flow board 15 would flow to the anode terminals of the membrane electrode assembles 133 through the lower casing 113.

This invention is related to a novel creation that makes a breakthrough in the art. Aforementioned explanations, however, are directed to the description of preferred embodiments according to this invention. Since this invention is not limited to the specific details described in connection with the preferred embodiments, changes and implementations to certain features of the preferred embodiments without altering the overall basic function of the invention are contemplated within the scope of the appended claims.

What is claimed is:

1. A fuel cell, comprising:
a fuel cell core component, including an anode current collection portion, at least one membrane electrode assembly, and a cathode current collection portion stacked in a sequential manner;
a casing, made of a plastic material for surrounding the fuel cell core component therein.

2. The fuel cell of claim 1, wherein the casing is made by injection molding process.

3. The fuel cell of claim 1, wherein the casing includes an upper casing and a lower casing.

4. The fuel cell of claim 3, wherein the upper casing is of an inverse-U configuration, and the lower casing is of an inverse-U configuration.

5. The fuel cell of claim 3, wherein the upper casing and the lower casing are pressed together by means of ultrasonic waves.

6. The fuel cell of claim 1, wherein the fuel cell core component is a flexible fuel cell core component.

7. The fuel cell of claim 1, wherein the fuel cell core component is made by means of printed circuit board(PCB) fabrication process.

8. A fuel cell, comprising:
a fuel cell core component, including an anode current collection portion, at least one membrane electrode assembly, and a cathode current collection portion stacked in a sequential manner;
a casing, made of a plastic material for surrounding the fuel cell core component therein.
a fuel flow board, made of a plastic material and joined to an outside surface of the casing, the surface having an inner side neighboring the anode current collection portion.

9. The fuel cell of claim 8, wherein the casing is made by injection molding process.

10. The fuel cell of claim 8, wherein the casing includes an upper casing and a lower casing.

11. The fuel cell of claim 10, wherein the upper casing is of an inverse-U configuration, and the lower casing is of an inverse-U configuration.

12. The fuel cell of claim 10, wherein the upper casing and the lower casing are pressed together by means of ultrasonic waves.

13. The fuel cell of claim 8, wherein the fuel flow board is made of injection molding process.

14. The fuel cell of claim 8, wherein the fuel flow board allows an anode fuel to flow through.

15. The fuel cell of claim 8, wherein the fuel flow board is pressed onto the outside surface of the casing by means of ultrasonic waves.

16. The fuel cell of claim 8, wherein the fuel cell core component is a flexible fuel cell core component.

17. The fuel cell of claim 8, wherein the fuel cell core component is made by means of PCB fabrication process.
